(19) United States
(12) Patent Application Publication
(10) Pub. No.: US 2017/0353247 A1
(43) Pub. Date: Dec. 7, 2017

(54) CONSTELLATION DESIGN FOR USE IN COMMUNICATION SYSTEMS

(71) Applicant: NEC Laboratories America, Inc., Princeton, NJ (US)

(72) Inventors: Fatih Yaman, Princeton, NJ (US); Shaoliang Zhang, Princeton, NJ (US); Eduardo Mateo Rodriquez, Tokyo (JP); Yoshihisa Inada, Tokyo (JP); Takaaki Ogata, Tokyo (JP)

(21) Appl. No.: 15/078,538

(22) Filed: Mar. 23, 2016

Related U.S. Application Data
(60) Provisional application No. 62/137,406, filed on Mar. 24, 2015.

(51) Int. Cl. H04B 10/54; H04B 10/50; H04B 10/69; H04B 10/25; H04B 10/40; H04B 10/61

(52) U.S. Cl. CPC H04B 10/541; H04B 10/504; H04B 10/612; H04B 10/25; H04B 10/40; H04B 10/69

(57) ABSTRACT

Methods and systems for communication with a modified constellation are provided. One of the methods includes coding, by a transmitter in the user equipment, an input data stream into a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit. The method further includes modulating, by the transmitter, the symbol stream into a transmission stream.

### RELATED APPLICATION INFORMATION

This application claims priority to provisional application Ser. No. 62/137,406 filed on Mar. 24, 2015, incorporated herein by reference in its entirety.

### BACKGROUND OF THE INVENTION

The present invention relates to optical communications and, in particular, to communications with a modified constellation.

In optical communications systems, incoming data signals are often converted into bit streams. There are numerous modulation formats of the incoming data signals. In quadrature amplitude modulation (QAM), for example, an in-phase and a quadrature signal, ninety degrees out of phase from one another, are amplitude-modulated to encode information. The result is a signal constellation which maps the different bit sequences that are possible for any given combination of amplitude levels on the two signals. For a four-point QAM constellation, each point (known as a “symbol”) encodes two bits. For an eight-point QAM constellation, each symbol encodes three bits.

High order modulation formats are very critical for optical communications. In such high order modulations, the signals are often converted into a constellation of bits wherein the constellation is highly symmetrical in order to maximize the Euclidean distance between the bits. Although such high symmetry benefits performance, it makes high order modulations highly susceptible to Cycle-Slip Errors (CSEs). In attempts to eliminate the penalty of CSEs, redundant pilot tones (also known as “over heads”) have been added to the signal. However, this process reduces the efficiency of the transmission of the signal. A process is therefore needed that reduces the risk of CSEs while not negatively affecting the efficiency of the transmission of the signal.

### SUMMARY

A method implemented in user equipment in an optical communications system, according to an embodiment of the present principles, is provided. The method includes coding, by a transmitter in the user equipment, an input data stream into a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit. The method further includes modulating, by the transmitter, the symbol stream into a transmission stream.

A method implemented in user equipment in an optical communications system, according to an embodiment of the present principles, is provided. The method includes demodulating, by a transmitter, a received signal to produce a symbol stream. The method further includes decoding the symbol stream to a bit stream symbol stream according to a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit.

An apparatus implemented for use in an optical communications system, according to an embodiment of the present principles, is provided. The apparatus includes a coder, the coder having a processor configured to code a transmission data stream into a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit. The apparatus further includes a transmitter configured to modulate the transmission symbol stream onto a transmitting signal, demodulate a received signal to produce a received symbol stream, and decode the received symbol stream to a received data stream, according to the constellation.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 shows a diagram of a constellation of a standard 8-Quadrature Amplitude Modulation (8QAM) system, also known as a star 8QAM system, in accordance with an embodiment of the present principles;

FIG. 2 shows a diagram of a constellation of a Hex8QAM system, in accordance with an embodiment of the present principles;

FIG. 3 shows a diagram of a constellation of a standard 8QAM system in which normalized Euclidean distances between the closest neighbors are marked, in accordance with an embodiment of the present principles;

FIG. 4 shows a diagram of a constellation of a Hex8QAM system in which normalized Euclidean distances between the closest neighbors are marked, in accordance with an embodiment of the present principles;

FIG. 5 shows a diagram of a constellation of an optimized Hex8QAM (O-Hex8QAM) system, in accordance with an embodiment of the present principles;

FIG. 6 shows a diagram of a constellation of an O-Hex8QAM system in which normalized Euclidean distances between the closest neighbors are marked, in accordance with an embodiment of the present principles;

FIG. 7 shows a flowchart of a method of communicating with a modified constellation, in accordance with an embodiment of the present principles;

FIG. 8 is a block diagram of a system for optimizing a constellation in accordance with the present principles;

FIG. 9 is a block diagram of a base station system for communication with an optimized constellation in accordance with the present principles;

FIG. 10 is a block diagram of a processing system in accordance with the present principles;

FIG. 11 is a block diagram of an optical transmission system in accordance with the present principles;

FIG. 12 is a block diagram of a transmitter in accordance with the present principles; and

FIG. 13 is a block diagram of a transmitter in accordance with the present principles.

### DETAILED DESCRIPTION OF PREFERRED EMBODIMENTS

In accordance with the present principles, systems and methods are provided for communication with a modified constellation in optical communications systems.

Quadrature Amplitude Modulation (QAM) is a technique by which a data signals are modulated. During the QAM modulation process, both the amplitude and the phase of a signal are modulated. In an 8QAM constellation, a digital signal is separated into 8 individual modulation states; each modulation state being assigned to a 3-digit unique bit set, wherein the 3-digit bit set determines the amplitude and phase of the modulated state. Each modulation state in the constellation is represented as a constellation point (known as a “symbol”).

One aspect of 8QAM constellations is that they do not satisfy the Gray-mapping condition. A Gray-mapping condition is satisfied when the closest neighboring symbols differ by exactly one bit. For 8-point, semi-optimum 2-dimensional constellations (such as 8QAM constellations), it is not possible to have perfect Gray-mapping. For data transmission, each symbol is assigned a number of bits to carry and, in transmission, the errors overwhelmingly occur between neighboring constellations. Gray-mapping ensures that, when a symbol is incorrectly assigned to a neighbor, the number of errors in binary bits is no more than one. For many constellations, such as Quadrature Phase-Shift Keying (QPSK) or 16QAM, this condition can be satisfied, but for 8QAM it cannot be.

According to an embodiment of the present principles, an Optimized Hex8QAM (O-Hex8QAM) constellation is presented in which the Euclidean distance (the distance between symbols in a constellation) of a Hex8QAM has been optimized in order to improve the Hex8QAM system's resiliency against Gaussian white noise caused by its lack of Gray-mapping. The present embodiments enlarge the distances between the symbols in a Hex8QAM constellation that are separated by more than one bit. Additionally, the O-Hex8QAM constellation does not have rotational symmetry. This lack of rotational symmetry causes the O-Hex8QAM constellation to be highly resistant to Cycle-Slip Errors (CSEs).

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

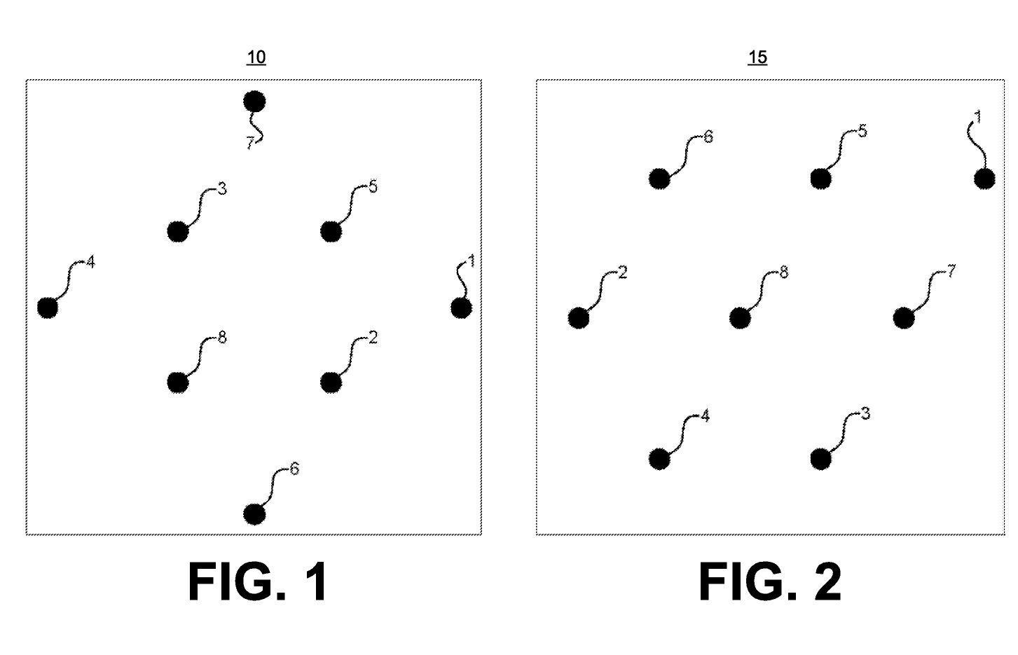

Referring now to the drawings in which like numerals represent the same or similar elements and initially to FIG. 1, a diagram of a constellation 10 of a standard 8QAM system is shown, also known as a star 8QAM system, in accordance with an embodiment of the present principles.

In the standard 8QAM constellation 10, each of the eight modulated states are located at a symbols 1, 2, 3, 4, 5, 6, 7, and 8, and are organized in such a way that the shaped formed by the placement of the symbols (1, 2, 3, 4, 5, 6, 7, 8) has 4-fold rotational symmetry. A shape with 4-fold rotational symmetry appears identical at rotation angles 0°, 90°, 180°, and 270°.

Since the constellation 10 has the same appearance at rotation angles 0°, 90°, 180°, and 270°, it is not possible to determine whether the constellation is the original constellation or a rotated copy of the original constellation. As a result of this inability to determine the orientation of the constellation, an 8QAM constellation 10 system is more susceptible to CSEs. These CSEs occur because it is not possible to determine which orientation of the constellation is the correct orientation after transmission of the signal.

Referring now to FIG. 2, a diagram of a constellation 15 of a Hex8QAM system is shown, in accordance with an embodiment of the present principles.

A Hex8QAM constellation 15 is an 8QAM constellation wherein the eight symbols (1, 2, 3, 4, 5, 6, 7, 8) are organized in a 2-dimensional, 8-point, honey-comb lattice. Due to the shape of the Hex8QAM constellation 15, the Euclidean distance between each symbol (1, 2, 3, 4, 5, 6, 7, 8) and its closest neighboring state is greater than in the 8QAM constellation 10 in FIG. 1a at the same signal power.

Unlike the 8QAM constellation 10 of FIG. 1, the Hex8QAM constellation 15 does not have 4-fold rotational symmetry. In fact, the Hex8QAM constellation 15 has no rotational symmetry. Therefore, the orientation of the constellation is more easily determined.

Symbols 2, 3, 4, 5, 6, 7, and 8 in the Hex8QAM constellation 15 cannot provide any information about the orientation of the constellation 15. This is because they are roughly the same distance away from the center of the constellation 15 and they are distributed equally in an angular direction. However, symbol 1 has a distinct power level from the rest of the symbols. Due to the placement of symbol 1, it is always possible to determine the orientation of the Hex8QAM constellation 15 because this power level can easily be detected at the receiver side of the transmission signal and can be told apart from the rest of the symbols. Once symbol 1 is determined, it can be used to correct for the phase rotation of the constellation 15. This makes the Hex8QAM constellation 15 less susceptible to CSEs.

In typical usage, since all symbols are occupied with equal probability, symbol 1 is received every eight symbols, on average. This provides an update rate on the phase correction at a relatively fast pace. It is also noted that, in cases where the transmission system suffers a relatively strong cycle-slip penalty, the ratio of the frequency of using symbol 1 can be increased at the expense of a reduced data rate.

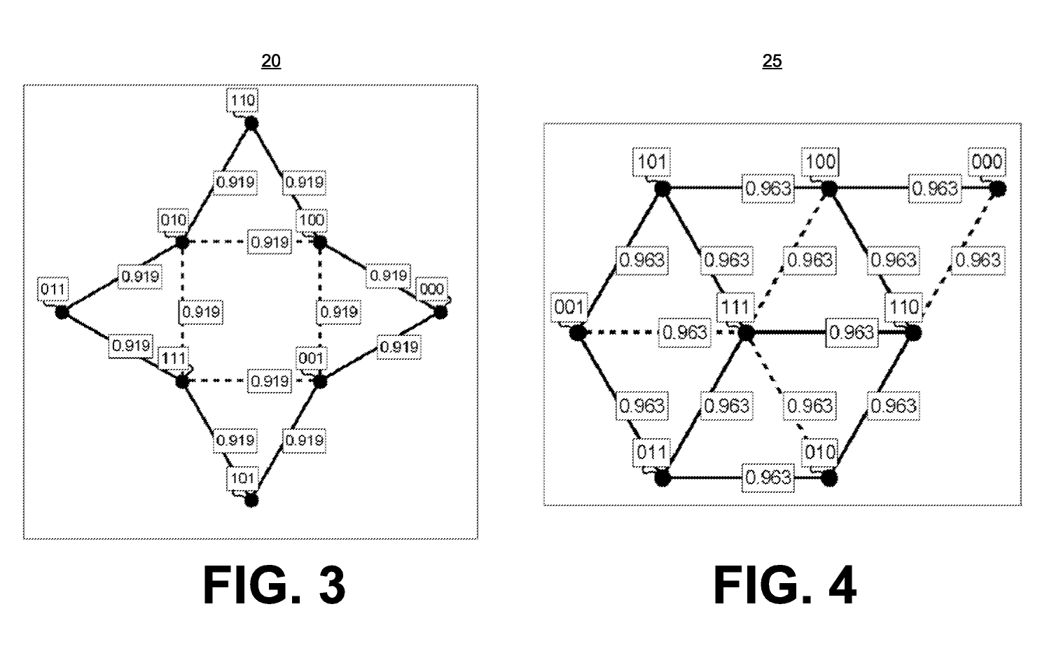

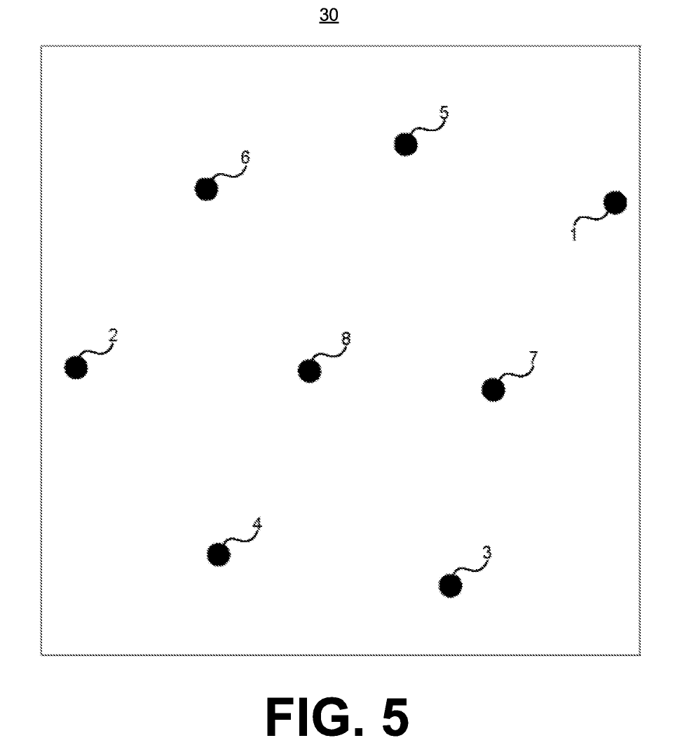

Referring now to FIGS. 3 and 4, a diagram of a constellation of a standard 8QAM constellation 20 and a diagram of a Hex8QAM system 25, in which normalized Euclidean distances between the closest neighbors are marked, are shown in accordance with embodiments of the present principles.

For both the modulation formats in FIGS. 3 and 4, the Euclidean distance is uniform between all neighboring symbols. In FIG. 3, the Euclidean distance between each of the symbols (1, 2, 3, 4, 5, 6, 7, 8) and their closest neighboring symbols in the standard 8QAM constellation 20 with 4-fold rotational symmetry is 0.919. In FIG. 4, the Euclidean distance between each of the symbols (1, 2, 3, 4, 5, 6, 7, 8) and their closest neighboring symbols in a Hex8QAM constellation 25 is 0.963. Therefore, the Hex8QAM constellation 25 has a Euclidean distance advantage over the 4-fold rotationally symmetric 8QAM constellation 10 due to the increased Euclidean distances providing for greater resiliency to Gaussian white noise.

The Euclidean distance between the symbols is not the only parameter in determining the quality of a signal. An additional factor to be considered is how the individual bits are mapped to the symbols. In FIGS. 3 and 4, the bit mappings for the individual symbols are shown. The bit mappings for each of the individual symbols are as follows:

| Symbol | Bit Map |
|---|---|
| 1 | 000 |
| 2 | 001 |
| 3 | 010 |
| 4 | 011 |
| 5 | 100 |
| 6 | 101 |
| 7 | 110 |
| 8 | 111 |

Since 8QAM constellations violate Gray-mapping, not every pair of neighboring symbols is separated by exactly one bit. There are four neighboring pairs in each of the constellations 20, 25 in FIGS. 3 and 4 in which neighboring symbols differ by two bits, violating the Gray-mapping condition. In FIGS. 3 and 4, these neighboring pairs are represented by dotted lines. In FIG. 3, these pairs of symbols that violate Gray-mapping are 2 and 5, 2 and 8, 3 and 5, and 3 and 8. In FIG. 4, these pairs are symbols 1 and 7, 2 and 8, 3 and 8, and 5 and 8.

According to an embodiment of the present principles, any penalty that arises from the presence of the pairs that violate the Gray-mapping condition is mitigated by adjusting the Euclidean distances between each of the symbols so as to increase the Euclidean distances between these pair. After such an adjustment, an O-Hex8QAM constellation is formed.

Referring now to FIG. 5, a diagram of a constellation 30 of an O-Hex8QAM system is shown, in accordance with an embodiment of the present principles.

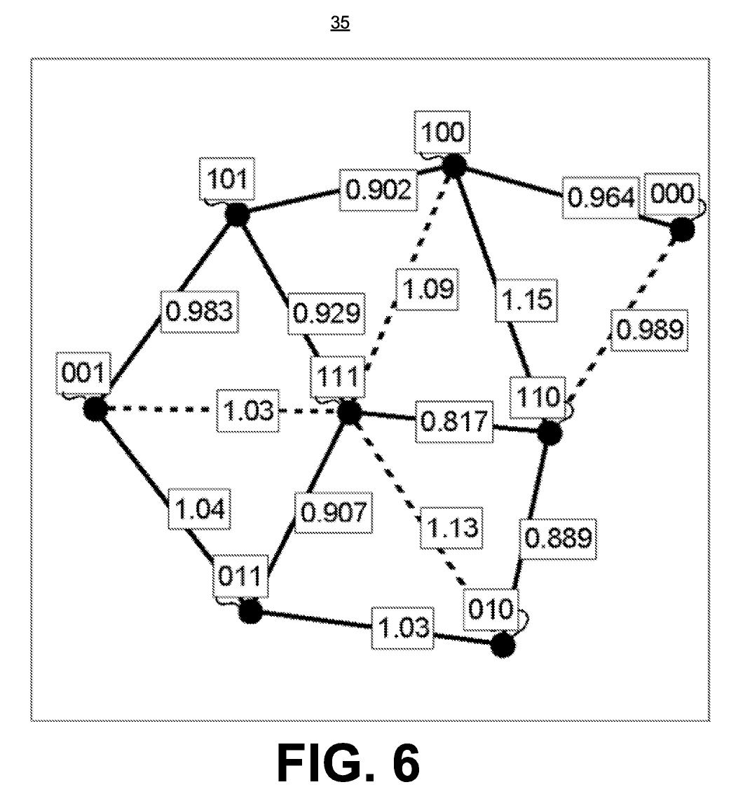

The symbols (1, 2, 3, 4, 5, 6, 7, 8) in the constellation 30 form a shape similar to the Hex8QAM, but with a greater Euclidean distance between each of the pairs of symbols that violate Gray-mapping. These Euclidean distances are shown, in more detail, in FIG. 6.

FIG. 6 shows a diagram of an example of a constellation 35 of an O-Hex8QAM system in which normalized Euclidean distances between the closest neighbors are marked, in accordance with an embodiment of the present principles. Unlike the constellations shown in FIGS. 1-4, in constellation 35, the symbols (1, 2, 3, 4, 5, 6, 7, 8) are not equally distant from each of their closest neighboring symbols. The distances between the pairs of symbols in the example O-Hex8QAM constellation 30 of FIG. 6 are as follows:

| Constellation | Euclidean |
|---|---|
| Point Pair | Distance |
| 1 and 5 | 0.964 |
| 1 and 7 | 0.989 |
| 2 and 4 | 1.04 |
| 2 and 6 | 0.983 |
| 2 and 8 | 1.03 |
| 3 and 4 | 1.03 |
| 3 and 7 | 0.889 |
| 3 and 8 | 1.13 |
| 5 and 6 | 0.902 |
| 5 and 7 | 1.15 |
| 5 and 8 | 1.09 |
| 6 and 8 | 0.929 |
| 7 and 8 | 0.817 |

Gaussian white noise causes the symbols to enlarge. Once the symbols come into contact with each other, it is not possible to tell whether a transmitted bit belongs to one symbol or the other. If the distance between the symbols is larger, a constellation can tolerate larger noise until the symbols come into contact with one another. The O-Hex8QAM constellation 35 has a Euclidean distance distribution that has been optimized to improve its resilience against Gaussian white noise.

The O-Hex8QAM constellation 35, like the regular Hex8QAM constellation 15, is not rotationally symmetrical. Unlike a regular Hex8QAM constellation 15, the O-Hex8QAM constellation 35 has no portion that is rotationally symmetrical. This is due partly because each of the pairs of the symbols are separated by a unique Euclidean distance.

The unique shape of the O-Hex8QAM constellation 35 causes the O-Hex8QAM constellation to be highly resilient to CSEs. This results in the signal being of a higher quality.

In standard 8QAM systems, redundant pilot tones (also known as “over heads”) are often added to the signal to reduce the penalty of CSEs. In some cases, a significant amount of pilot tones are transmitted. The ratio of these pilot tones can be up to 5% of the data rate. In an embodiment of the present principles, when redundant pilot tones are added to decrease any penalty resulting from CSEs, use of the O-Hex8QAM constellation 30 reduces, or even eliminates, the number of redundant pilot needed to decrease the penalty. In another embodiment, a Digital Signal Processor (DSP) is modified to incorporate the use of pilots with the O-Hex8QAM constellation. In an embodiment of the present principles, when the number of pilot tones is reduced with use of the O-Hex8QAM constellation 30, spectral efficiency is increased and the cost of transmission per bit is reduced. In another embodiment, when the number of pilot tones is eliminated with the use of the O-Hex8QAM constellation, the transceiver design is lower in complexity.

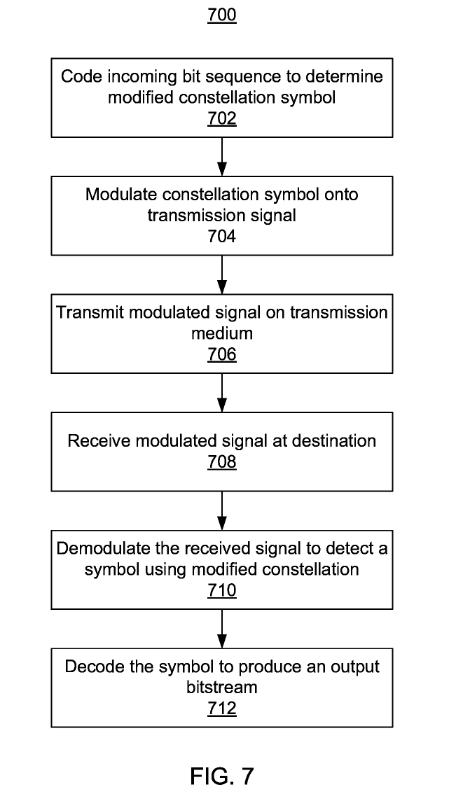

Referring now to FIG. 7, a flowchart of a method 700 method for communicating with a modified constellation is shown, in accordance with an embodiment of the present principles.

At block 702, an incoming bit sequence is coded into a symbol stream in accordance with a constellation that has at least two symbols which are separated by more than one bit and that has Euclidian distances between neighboring symbols having more than one bit difference enlarged so as to increase resiliency of the constellation to Gaussian white noise such as, e.g., the constellation 600 as shown in FIG. 6. In an embodiment, the constellation is an 8QAM constellation. In another embodiment, the constellation is a Hex-8QAM constellation.

At block 704, the symbol stream is modulated onto a transmission signal such as, e.g., a laser beam or another appropriate medium. At block 706, the modulated transmission signal is then launched onto a transmission medium such as, e.g., a fiber optic cable.

At block 708, the modulated transmission signal is modulated from the transmission medium at the destination. At block 710, the modulated signal is then demodulated to detect the corresponding symbol using the same modified constellation that was used at block 702. At block 712, the symbol is then translated into a corresponding bit sequence and the bit sequence is output.

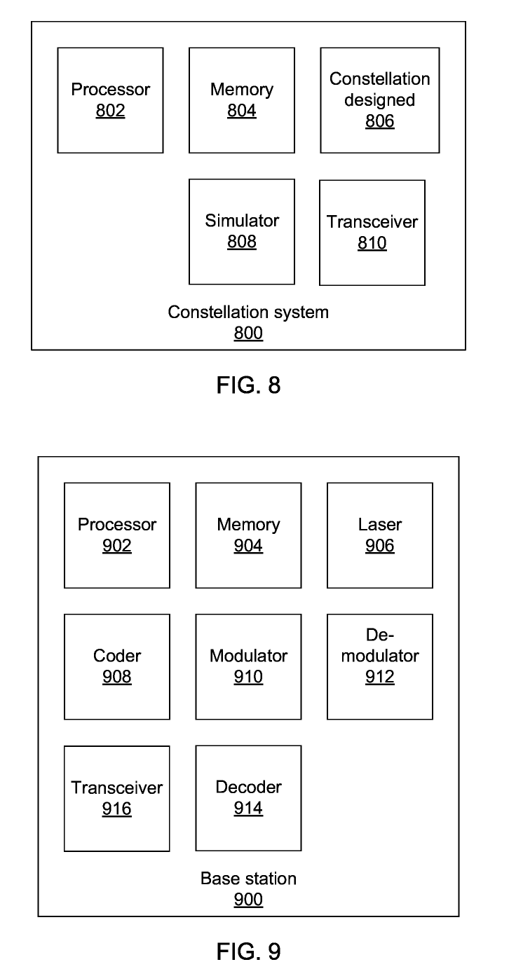

Referring now to FIG. 8, a system 800 for constellation design and implementation is shown. The system 800 includes a hardware processor 802 and memory 804. There may be one or more functions performed by the processor that take the form of software that may be implemented as software that is stored in the memory 804 and executed by processor 802. Alternatively, the functions may be implemented by one or more discrete hardware components, for example as application-specific integrated chips or field programmable gate arrays.

In an embodiment of the present principles, the system includes a constellation designer 806 and a simulator 808. The system may also include a transceiver 810 for receiving and transmitting a signal. It is noted that the system may also include a separate transmitter and receiver. The constellation designer 806 performs an initial design of the constellation according to, e.g., minimized Euclidean distances between neighboring points and assigned bit sequence mappings to each of points in the constellation. The simulator 808 then simulates the constellation at various Signal-to-Noise Ratios (SNRs) with various adjustments using, e.g., Monte Carlo simulations. Based on the simulations, an optimal constellation for a given SNR is determined and the constellation designer 806 performs an adjustment to the constellation, storing the optimized constellation in memory 804.

Referring now to FIG. 9, a base station 900 in a communication system is shown. It is specifically contemplated that this base station 900 may be used in consumer equipment or, alternatively, may be used in a large, commercial grade data communications center. As with the constellation system 800 described above, the base station 900 includes a hardware processor 902 and a memory 904. In addition, the base station 900 includes, e.g., a laser 906 or some other form of signal generating device.

A coder 908 uses the processor 902 to convert the bits of an input bit stream into symbols that the modulator 910 modulates onto a laser beam from laser 906. This forms an outgoing transmission, which is launched onto a transmission medium such as fiber optic cable 806. Other signals may be received over that transmission medium or over another, at a same wavelength or at some other wavelength. The base station may include a transceiver 916 for receiving and transmitting signals. The demodulator 912 detects symbols within the received signal by measuring, e.g., the amplitude of an I and Q signal therewithin. A decoder 914 then uses processor 902 to convert the symbols into a corresponding bit stream and outputs that bit stream.

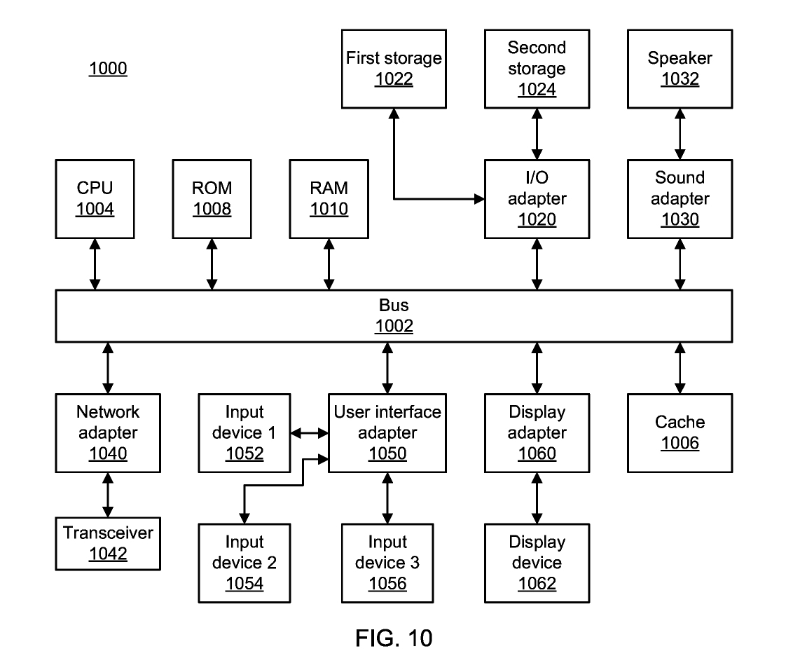

Referring now to FIG. 10, an exemplary processing system 1000 is shown which may represent the constellation system 800 or the base station 900. The processing system 1000 includes at least one processor (CPU) 1004 operatively coupled to other components via a system bus 1002. A cache 1006, a Read Only Memory (ROM) 1008, a Random Access Memory (RAM) 1010, an input/output (I/O) adapter 1020, a sound adapter 1030, a network adapter 1040, a user interface adapter 1050, and a display adapter 1060, are operatively coupled to the system bus 1002.

A first storage device 1022 and a second storage device 1024 are operatively coupled to system bus 1002 by the I/O adapter 1020. The storage devices 1022 and 1024 can be any of a disk storage device (e.g., a magnetic or optical disk storage device), a solid state magnetic device, and so forth. The storage devices 1022 and 1024 can be the same type of storage device or different types of storage devices.

A speaker 1032 is operatively coupled to system bus 1002 by the sound adapter 1030. A transceiver 1042 is operatively coupled to system bus 1002 by network adapter 1040. A display device 1062 is operatively coupled to system bus 1002 by display adapter 1060.

A first user input device 1052, a second user input device 1054, and a third user input device 1056 are operatively coupled to system bus 1002 by user interface adapter 1050. The user input devices 1052, 1054, and 1056 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 1052, 1054, and 1056 can be the same type of user input device or different types of user input devices. The user input devices 1052, 1054, and 1056 are used to input and output information to and from system 1000.

Of course, the processing system 1000 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 1000 are readily contemplated by one of ordinary skill in the art given the teachings of the present principles provided herein.

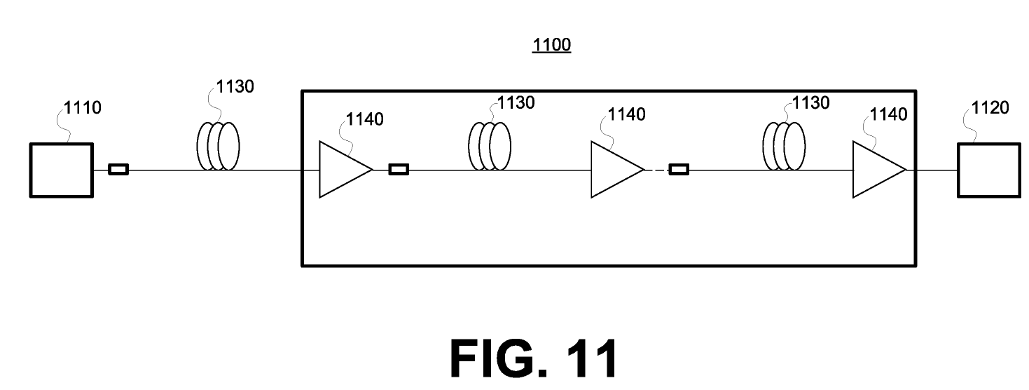

Referring now to FIG. 11, an optical transmission system 1100, capable of using the O-Hex8QAM constellation, is shown in accordance with an embodiment of the present principles.

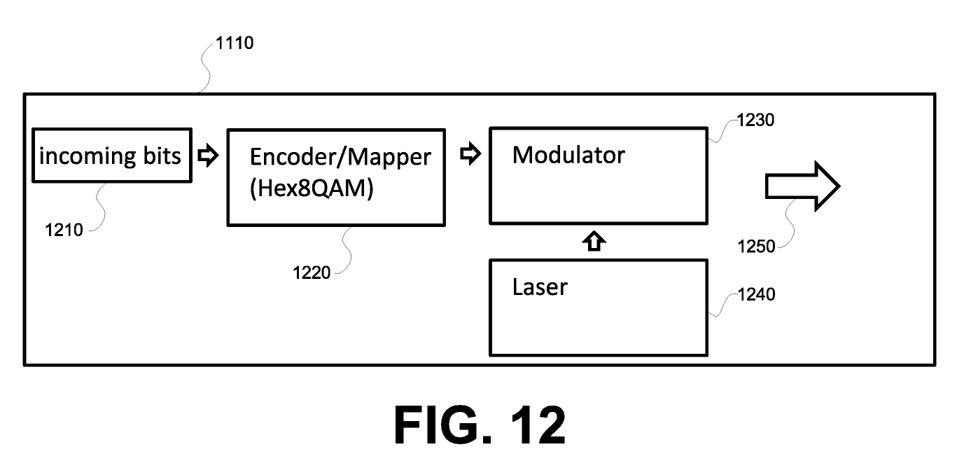

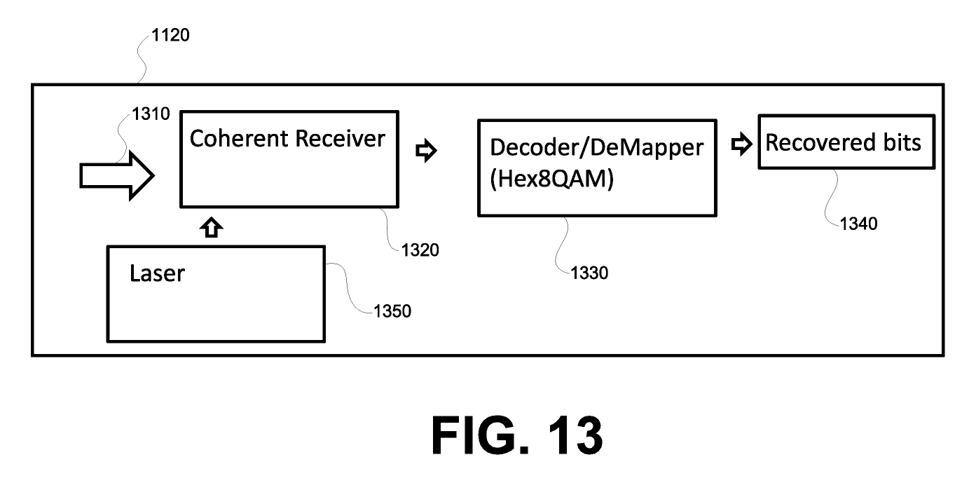

The system 1100 includes a transmitter 1110 configured to encode, modulate, and transmit an incoming signal and a receiver 1120 configured to receive the signal transmitted from the transmitter 1120 and further demodulate and decode the received signal. The transmitter 1110 and receiver 1120 are further shown and described in FIGS. 12-13.

In an embodiment, the system 1100 includes one or more optical fibers 1130 configured to carry the signal transmitted by the transmitter 1110. In another embodiment, the system 1100 includes one or more amplifiers 1140 configured to amplify the signal carried by the one or more optical fibers 1130.

Referring now to FIG. 12, the transmitter 1110 of FIG. 11 is shown in accordance with an embodiment of the present principles.

In an embodiment, the transmitter 1110 includes an encoder or mapper 1220 designed to encode an input signal 1210 according to a Hex8QAM constellation. The transmitter 1110 further includes a modulator 1230 designed to modulate the encoded signal. In an embodiment, the encoded signal is modulated onto a laser beam using a laser 1240. Once the input signal 1210 has been encoded and modulated, an output signal 1250 can be transmitted by the transmitter 1110. The transmitter 1110 may include additional structural elements such as, e.g., digital signal processing blocks which may be implemented in an Application-Specific Integrated Circuit (ASIC) or a Field-Programmable Gate Array (FPGA).

Referring now to FIG. 13, the receiver 1120 of FIG. 11 is shown in accordance with an embodiment of the present principles.

In an embodiment, the receiver 1120 includes a coherent receiver 1320 configured to receive a signal 1310 transmitter by the transmitter 1110. In an embodiment, the coherent receiver may include a laser 1350. The receiver 1120 further includes decoder or demapper 1330 configured to decode or demap the signal 1310 to a bit stream symbol stream according to a Hex8QAM constellation of symbols, allowing recovered bits 1330 from the bit stream symbol stream to be acquired. The receiver 1120 may include additional structural elements such as, e.g., digital signal processing blocks which may be implemented in an ASIC or an FPGA.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

It should be understood that embodiments described herein may be entirely hardware, or may include both hardware and software elements which includes, but is not limited to, firmware, resident software, microcode, etc.

1. A method implemented in a user equipment in an optical communications system, the method comprising:
coding, by a transmitter in the user equipment, an input data stream into a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit; and
modulating, by the transmitter, the symbol stream into a transmission stream.

2. The method of claim 1, wherein the constellation is an 8-symbol quadrature amplitude modulation constellation.

3. The method of claim 2, wherein the 8-symbol quadrature amplitude modulation constellation is a hexagonal 8-symbol quadrature amplitude modulation constellation.

4. The method of claim 1, further comprising modifying the constellation for a predetermined signal-to-noise ratio.

5. The method of claim 4, further comprising performing Monte-Carlo simulations for the predetermined signal-to-noise ratio on a multitude of possible constellations, wherein no two possible constellations have the same distance between all pairs of neighboring symbols.

6. The method of claim 1, wherein the transmitter includes a laser.

7. The method of claim 6, wherein the signal stream is modulated onto a laser beam using the laser.

8. A method implemented in a user equipment in an optical communications system, the method comprising:
demodulating, by a transmitter, a received signal to produce a symbol stream; and
decoding the symbol stream to a bit stream symbol stream according to a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit.

9. The method of claim 8, wherein the constellation is an 8-symbol quadrature amplitude modulation constellation.

10. The method of claim 9, wherein the 8-symbol quadrature amplitude modulation constellation is a hexagonal 8-symbol quadrature amplitude modulation constellation.

11. The method of claim 8, further comprising performing Monte-Carlo simulations for a predetermined signal-to-noise ratio on a multitude of possible constellations, wherein no two possible constellations have the same distance between all pairs of neighboring symbols.

12. The method of claim 8, further comprising modifying the constellation for a predetermined signal-to-noise ratio.

13. The method of claim 12, further comprising performing Monte-Carlo simulations for a predetermined signal-to-noise ratio on a multitude of possible constellations, wherein no two possible constellations have the same distance between all pairs of neighboring symbols.

14. An apparatus used in an optical communications system, the apparatus comprising:
a coder, the coder having a processor configured to code a transmission data stream into a constellation of symbols having at least two neighboring symbols therein which differ by more than one bit and which are separated by a modified Euclidean distance to increase a Gaussian white noise resiliency of the at least two neighboring symbols with respect to remaining symbols, the remaining symbols being separated by the Euclidean distance of exactly one bit; and
a transmitter configured to:
modulate the transmission symbol stream onto a transmitting signal;
demodulate a received signal to produce a received symbol stream; and
decode the received symbol stream to a received data stream, according to the constellation.

15. The base station of claim 14, wherein the constellation is an 8-symbol quadrature amplitude modulation constellation.

16. The apparatus of claim 15, wherein the 8-symbol quadrature amplitude modulation constellation is a hexagonal 8-symbol quadrature amplitude modulation constellation.

17. The apparatus of claim 14, wherein the transmitter includes a laser.

18. The method of claim 17, wherein the laser is configured to modulate the signal stream onto a laser beam.

19. The apparatus of claim 14, wherein the processor is further configured to modify the constellation for a predetermined signal-to-noise ratio.

20. The apparatus of claim 19, wherein the processor is further configured to perform Monte-Carlo simulations for a predetermined signal-to-noise ratio on a multitude of possible constellations, wherein no two possible constellations have the same distance between all pairs of neighboring symbols.
